(19) United States
(12) Patent Application Publication
(10) Pub. No.: US 2011/0181725 A1
(43) Pub. Date: Jul. 28, 2011

(54) OPTICAL SENSOR DEVICE FOR VEHICLE

(75) Inventors: Mitsuyasu Matsuura, Chiryu-city (JP); Toshiki Isogai, Nagoya-city (JP); Keiko Akiyama, Kariya-city (JP); Keishi Kato, Nishio-city (JP); Toshihiro Hattori, Okazaki-city (JP); Kazuyoshi Akiba, Nagoya-city (JP)

(73) Assignees: NIPPON SOKEN, INC., Nishio-city (JP); DENSO CORPORATION, Kariya-city (JP)

(21) Appl. No.: 13/009,090

(22) Filed: Jan. 19, 2011

(30) Foreign Application Priority Data
Jan. 27, 2010 (JP) 2010-15384

(51) Int. Cl. H04N 7/18; G03B 17/02

(52) U.S. Cl. 348/148; 359/508; 348/E07.085

(57) ABSTRACT

A camera unit is provided in a hollow portion of an electric motor. A rotor is rotatably arranged at an outer periphery of a stator. A cylindrical motor casing is attached to the rotor. A lens cover is attached to the motor casing at a position of a front side of a lens of the camera unit. The lens cover is rotated together with the motor casing and the rotor, so that attachment adhered to an outer surface of the lens cover is removed by centrifugal force.

### CROSS REFERENCE TO RELATED APPLICATION

This application is based on Japanese Patent Application No. 2010-015384 filed on Jan. 27, 2010, the disclosure of which is incorporated herein by reference.

### FIELD OF THE INVENTION

The present invention relates to an optical sensor device for a vehicle, such as, a camera, a laser and so on, which has an optical sensor.

### BACKGROUND OF THE INVENTION

Recently, an optical sensor device, such as a camera, a laser and so on has been mounted in a vehicle. In a case that the optical sensor device of this kind is mounted in the vehicle, it may be a problem that water droplet, mud, dust and so on may be adhered to a lens surface for a lens of the optical sensor device. According to a prior art, for example, as disclosed in Japanese Utility Model No. 3010938, an optical sensor device is accommodated in a casing and a lens cover is provided at a front side of the optical sensor device, in order to avoid a situation that any attachment may be adhered to a lens surface of a lens for the optical sensor device.

In addition, the lens cover is rotated to generate centrifugal force in order to remove any attachment adhered to a surface of the lens cover.

According to the above prior art (JP Utility Model No. 301938), an electric motor is used for rotating the lens cover. It is necessary to rotate the lens cover at a predetermined high speed in order to remove the attachment from the surface of the lens cover. It is, therefore, necessary to use an electric motor having a predetermined large output power (a large-sized electric motor). When the large-sized electric motor is used for the optical sensor device, it may be a problem that the optical sensor device itself may become larger. Then, it may be a problem in view of easily mounting the optical sensor device in the vehicle and/or in view of its design.

### SUMMARY OF THE INVENTION

The present invention is made in view of the above problems. It is an object of the present invention to provide an optical sensor device, which is good in its design and easier in mounting the same in the vehicle. The optical sensor device of the present invention has a structure, according to which a lens cover is provided at a front side of a lens of an optical sensor, wherein a large size of the device is avoided. In addition, it is possible to appropriately remove any attachment adhered to an outer surface of the lens cover.

According to a feature of the invention (for example, as defined in the appended claim 1), an optical sensor unit is provided in a hollow portion of an electric motor having a rotor, wherein a lens is arranged to be coaxial with a rotational axis of the electric motor. Accordingly, a size of an optical sensor device may be equal to that of the electric motor even when the optical sensor unit is incorporated into the electric motor.

In addition, a lens cover, which is provided at a front side of the optical sensor unit, is attached to the rotor so that the lens cover is rotated together with the rotor when the electric motor is rotated. Therefore, even when attachment (such as, water droplet, mud, dust and so on) is adhered to an outer surface of the lens cover, a centrifugal force is applied to the attachment when the lens cover is rotated, so that the attachment is sufficiently removed from the outer surface of the lens cover.

Furthermore, if a lens of an optical sensor was rotated, it would be necessary to accurately adjust a mechanical structure and so on in order to eliminate an adverse affect to optical characteristics. However, according to the present invention, such accurate adjustment is not necessary for a structure, in which not the lens but the lens cover is rotated.

According to another feature of the present invention (for example, as defined in the appended claim 2), the rotor is arranged at an outer periphery of a stator of the electric motor, and the hollow portion is formed in an inside of the stator.

According to such a feature, the size of the optical sensor device may be equal to that of the electric motor even when the optical sensor unit is incorporated into the electric motor. And even when the attachment (such as, water droplet, mud, dust and so on) is adhered to the outer surface of the lens cover, the attachment is sufficiently removed from the outer surface of the lens cover.

According to a further feature of the present invention (for example, as defined in the appended claim 3), the rotor is arranged at an inner periphery of a stator of the electric motor, and the hollow portion is formed in an inside of the rotor.

In the same manner to the above feature of the claim 2, according to the feature for the claim 3, the size of the optical sensor device may be equal to that of the electric motor even when the optical sensor unit is incorporated into the electric motor. And even when the attachment (such as, water droplet, mud, dust and so on) is adhered to the outer surface of the lens cover, the attachment is sufficiently removed from the outer surface of the lens cover.

According to a still further feature of the present invention (for example, as defined in the appended claim 4), the lens cover is rotated at a rotational speed higher than 2500 [rpm], which is necessary for removing the attachment adhered to the outer surface of the lens cover.

A certain amount of the centrifugal force is applied to the attachment adhered to a portion away from the rotational axis, while only a little amount of the centrifugal force may be applied to the attachment adhered to such a portion close to the rotational axis. Therefore, there may be a danger that the attachment adhered to the portion close to the rotational axis may not be sufficiently removed even when the lens cover is rotated.

However, according to a still further feature of the present invention (for example, as defined in the appended claim 5), a concavo-convex portion having multiple concave portions and convex portions, which has a configuration satisfying super-hydrophobic requirement expressed by mathematical formula of Cassie, is formed on an outer surface of the lens cover at such an area around the rotational axis of the electric motor. As a result, the attachment adhered to the portion close to the rotational axis can be also sufficiently removed.

According to a still further feature of the present invention (for example, as defined in the appended claim 6), a thickness of the concavo-convex portion in a direction perpendicular to the outer surface of the lens cover is less than 100 [nm].

Therefore, the thickness of the concavo-convex portion in the direction perpendicular to the outer surface is made to be less than one-fourth (¼) of the wave length of the visible light, and thereby the visible light is not blocked by the concavo-convex portion so that a photographing performance can be properly maintained at a high level.

According to a still further feature of the present invention (for example, as defined in the appended claim 7), a ratio of an area of an opening side surface of the concave portion with respect to an area of a top surface portion of the convex portion is larger than 9.

Therefore, a pitch of the concavo-convex is within a range of the wave length of the visible light, and thereby the visible light is not blocked by the concavo-convex portion so that a photographing performance can be properly maintained at a high level.

According to a still further feature of the present invention (for example, as defined in the appended claim 8), a concave portion or a convex portion, which has a configuration satisfying super-hydrophobic requirement expressed by mathematical formula of Cassie, is formed on an outer surface of the lens cover at such a position around the rotational axis of the electric motor.

In a similar manner to the feature of the above claim 5, the attachment adhered to the portion close to the rotational axis can be also sufficiently removed.

According to a still further feature of the present invention (for example, as defined in the appended claim 9), a thickness of the concave portion or the convex portion in a direction perpendicular to the outer surface of the lens cover is less than 100 [nm], in a similar manner to the claim 6.

Therefore, the thickness of the concave portion or the convex portion in the direction perpendicular to the outer surface is made to be less than one-fourth (¼) of the wave length of the visible light, and thereby the visible light is not blocked by the concave portion or the convex portion so that a photographing performance can be properly maintained at a high level.

According to a still further feature of the present invention (for example, as defined in the appended claim 10), a heating device is provided at a portion close to the lens cover for heating the outer surface of the lens cover.

It is, therefore, possible to prevent the outer surface of the lens cover from being misted over, in addition to the attachment being removed.

According to a still further feature of the present invention (for example, as defined in the appended claim 11), an electronic control unit is provided for receiving a gear position signal, so that the electronic control unit operates the electric motor when it determines that a gear position is in an “R” position.

Namely, when the vehicle is moving in the backward direction, the lens cover is rotated in order that the attachment adhered to the outer surface of the lens cover will be properly removed.

According to a still further feature of the present invention (for example, as defined in the appended claim 12), an electronic control unit is provided for receiving a rain signal, so that the electronic control unit operates the electric motor when it determines that it is in a raining condition.

Therefore, when it is raining, in other words, when it is a condition that the attachment may be easily adhered to the outer surface of the lens cover, the lens cover is rotated in order that the attachment adhered to the outer surface of the lens cover is properly removed.

According to a still further feature of the present invention (for example, as defined in the appended claim 13), an electronic control unit is provided for receiving a wiper signal, so that the electronic control unit operates the electric motor when it determines that a wiper device is being operated.

Therefore, when the wiper device is being operated, in other words, when it is a condition that the attachment may be easily adhered to the outer surface of the lens cover, the lens cover is rotated in order that the attachment adhered to the outer surface of the lens cover is properly removed.

According to a still further feature of the present invention (for example, as defined in the appended claim 14), an electronic control unit is provided for receiving a window signal, so that the electronic control unit operates the electric motor when it determines that a vehicle window closed.

In a case that the optical sensor device is mounted to the vehicle at such a position, at which a vehicle driver may easily touch the optical sensor device by his hand, for example at a door mirror, the optical sensor device is not operated unless the vehicle window is closed. As a result, it is possible to prevent the vehicle driver from accidentally touching the rotating lens cover. A safety can be thus assured.

According to a still further feature of the present invention (for example, as defined in the appended claim 15), an electronic control unit having an image comparing portion is provided for memorizing image information photographed by the optical sensor unit, and the image comparing portion compares a current image information with a memorized previous image information, wherein an operation of the electric motor is stopped when the image comparing portion determines that there is no difference between the above two image information.

After the attachment has been removed, there is no substantial change in the photographed images even when the lens cover is rotated. Therefore, it is possible to stop the operation of the electric motor when the attachment has been removed. It is, therefore, possible to reduce electrical power consumption.

### BRIEF DESCRIPTION OF THE DRAWINGS

The above and other objects, features and advantages of the present invention will become more apparent from the following detailed description made with reference to the accompanying drawings. In the drawings:

FIGS. 1A and 1B are schematic views showing an optical sensor device for a vehicle according to a first embodiment of the present invention, wherein FIG. 1A is a top plan view of the optical sensor device and FIG. 1B is a cross sectional view of the optical sensor device and a block diagram for an electronic control unit;

FIG. 2 is a schematic view showing a vehicle body to which the optical sensor device is mounted;

FIG. 3A is a schematic top plan view showing a lens cover;

FIGS. 3B and 3C are enlarged schematic views showing the lens cover on which a concavo-convex portion is formed, wherein FIG. 3B is a top plan view and FIG. 3C is a cross sectional view;

FIG. 4 is a schematic perspective view showing the concavo-convex portion formed on an outer surface of the lens cover;

FIG. 5A is a schematic view showing a roll-down test method;

FIG. 5B is a graph showing measurement result for adherence with respect to volume of droplet;

FIGS. 6A to 6D are schematic views showing experimental results;

FIG. 7 is a flow chart showing a process to be carried out by a camera ECU;

FIGS. 8A to 8C are schematic views, corresponding to FIGS. 3A to 3C, showing a modification of the concavo-convex portion;

FIGS. 9A to 9C are schematic views, also corresponding to FIGS. 3A to 3C, showing a modification of a convex portion;

FIGS. 10A to 10C are schematic views, also corresponding to FIGS. 3A to 3C, showing a further modification of a convex portion;

FIGS. 11A and 11B are schematic perspective views, showing relevant portions of an optical sensor device according to a second embodiment of the present invention; and

FIGS. 12A to 12D are schematic perspective views, showing relevant portions of an optical sensor device according to a third embodiment of the present invention.

### DETAILED DESCRIPTION OF THE PREFERRED EMBODIMENTS

### First Embodiment

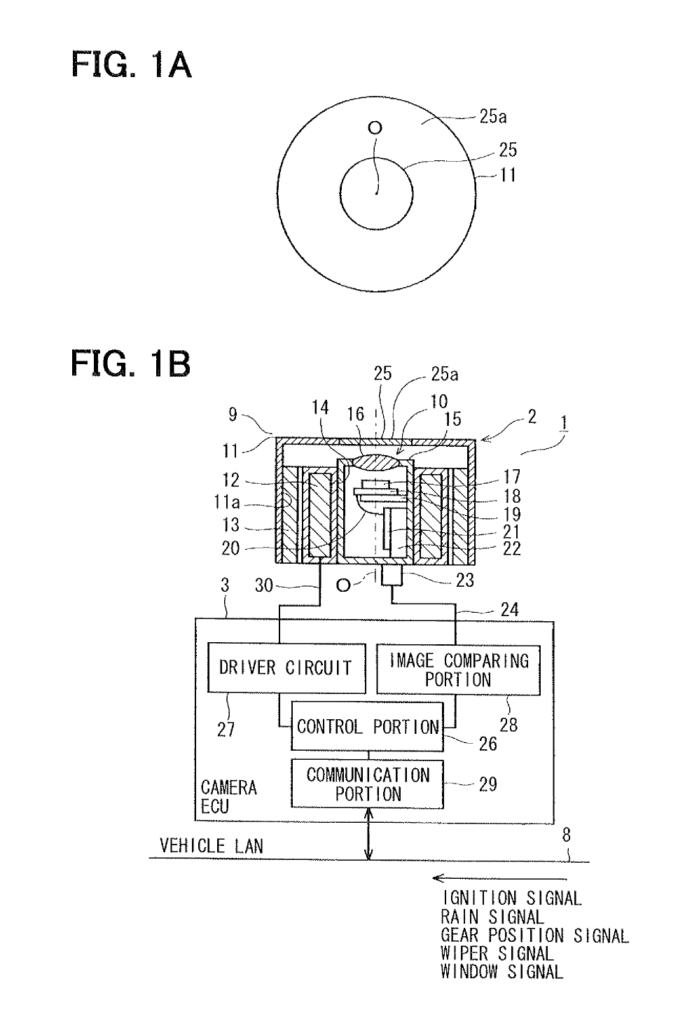

A first embodiment, in which the present invention is applied to a vehicle camera device, which is one of optical sensor devices, will be hereinafter explained with reference to the drawings of FIGS. 1 to 10.

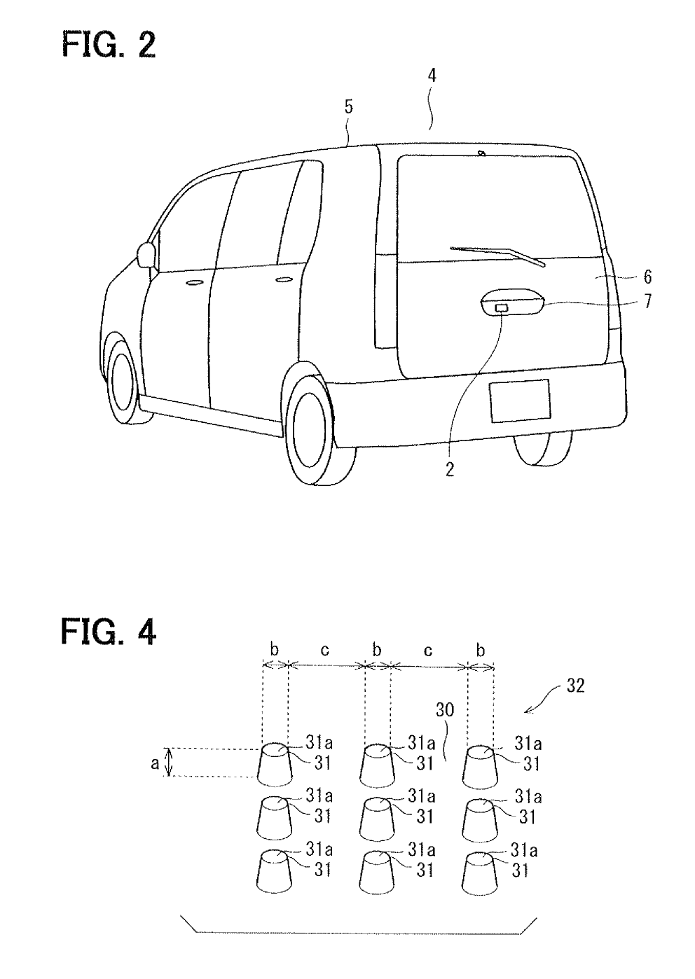

A vehicle camera device 1 (the optical sensor device of the present invention) is composed of, as shown in FIGS. 1A and 1B, a camera assembly 2 and a camera ECU (an electronic control unit) 3. As shown in FIG. 2, the camera unit 2 is fixed to a part of a vehicle body 5, for example, to a door knob 7 for a rear door 6 for opening and closing a trunk room of a vehicle 4. Therefore, the camera unit 2 is used as a back-view camera photographing a vehicle backside, when the vehicle 4 is moved in a backward direction. The camera ECU 3, which is one of ECUs mounted in the vehicle 4, is connected to a vehicle LAN 8.

The camera unit 2 is composed of an electric motor 9 and a camera unit (an optical sensor unit) 10. The electric motor 9 is an abduction type motor, which is composed of a cup-shaped motor casing 11 opening to a downward direction, a cylindrical stator 12 arranged in an inside of the motor casing 11, and an outer rotor 13 (a rotor) arranged at an outer periphery of the stator 12, wherein the outer rotor 13 is fixed to an inner peripheral wall 11a of the motor casing 11. A hollow portion 14 is formed in the inside of the cylindrical stator 12, so that the camera unit 10 is arranged in the hollow portion 14.

A camera housing 15 is arranged in the inside of the stator 12. A lens 16 having an elliptical cross section is provided at an upper portion of the camera housing 15. An imaging device 17 is provided in the camera housing 15 at a backside of the lens 16 (at a lower side in the drawing of FIG. 1B). A substrate 18, on which the imaging device 17 is mounted, is supported by a supporting member 19. A substrate 21 for an image data processing device is supported by another supporting member 22, wherein the substrate 18 for the imaging device 17 and the substrate 21 for the image data processing device are connected to each other via wirings 20.

An image taken by the lens 16 of the camera unit 10 is converted by the imaging device 17 into electronic image data signals, which are outputted from the substrate for the imaging device 17 to the substrate 21 for the image data processing device via the wiring 20. The electronic image data signals are processed by electronic circuits of the substrate 21 for the image data processing device. Such data-processed image signals are outputted from the camera assembly 2 to the camera ECU 3 through a data wire 24, which is connected to a connector 23.

A lens cover 25 of a disc shape is provided at an upper portion of the motor casing 11 (at a front side of the lens 16 of the camera unit 10: an upper side in the drawing of FIG. 1B) in such a way that the lens cover 25 is built in the motor casing 11. The lens cover 25 is made of transparent and colorless material, such as polycarbonate resin, acrylic resin or the like. An outer diameter of the lens cover 25 is slightly larger than that of the lens 16 of the camera unit 10. A center of the lens cover 25 as well as a center of the lens 16 of the camera unit is coaxial with a rotational axis of the electric motor 9 (as indicated by a one-dot-chain line O in FIG. 1B). An outer surface 25a of the lens cover 25 is finished by water-repellent treatment, so that a hydrophobic film is formed (coated) on the outer surface 25a of the lens cover 25. As a result, any attachment is not easily adhered to the outer surface 25a of the lens cover 25.

The camera ECU 3 is composed of; a control portion 26; a driver circuit 27 (also referred to as a motor driving means); an image comparing portion 28 (also referred to as an image comparing means); and a communication portion 29 (also referred to as a gear position receiving means, a rain condition receiving means, a wiper operating condition receiving means, or a window condition receiving means). The control portion 26 is mainly composed of a micro-computer for controlling an operation of the camera ECU 3 by carrying out control programs installed therein in advance.

The driver circuit 27 is connected to the stator 12 via a power supply line 30. When a command signal from the control portion 26 is inputted to the driver circuit 27, an electrical operation power is supplied from a vehicle battery (not shown) to the stator 12 to thereby rotate the outer rotor 13. Since the outer rotor 13 and the lens cover 25 are integrally formed by means of the motor casing 11, the lens cover 25 is rotated together with the outer rotor 13.

When the data-processed image signals are inputted from the camera assembly 2 to the image comparing portion 28 via the data wire 24, the image comparing portion 28 memorizes such inputted image signals and compares the inputted image signals (current image) with image signals previously memorized (memorized immediately before the currently inputted image signals). Then, the image comparing portion 28 determines whether there is any difference between them (the current image signals and the previous image signals), and outputs its determination result to the control portion 26. The communication portion 29 has a function of an interface with the vehicle LAN 8, so that the communication portion 29 receives various kinds of information from various ECUs and/or sensors via the vehicle LAN 8 to input them to the control portion 26. The various information may include; an ignition signal indicating whether or not an ignition switch is turned on or off; a rain signal indicating whether it is raining or not; a gear position signal indicating a gear position of the vehicle; a wiper operation signal indicating whether a wiper is operating or not; a window condition signal indicating an opening (or a closing) condition of a vehicle window; and so on.

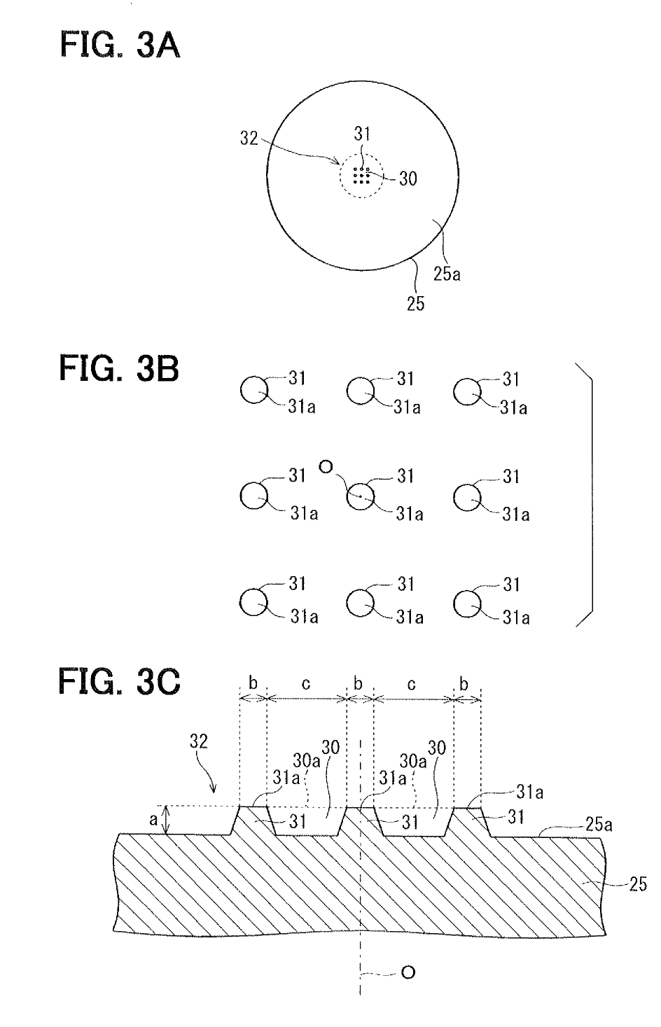

The lens cover 25 will be further explained with reference to FIGS. 3A to 3C and 4. The outer surface 25a of the lens cover 25 is formed on an upper side surface thereof, which is opposite to a lower side surface of the lens cover 25 facing to the lens 16 of the camera unit 10. A concavo-convex portion 32 is formed at a center area of the outer surface 25a of the lens cover 25, which is around the center of the outer surface 25a (the rotational axis of the electric motor 9). In the concavo-convex portion 32, concave portions 30 and convex portions 31 are formed. In the embodiment shown in FIGS. 3A to 3C and 4, nine convex portions 31 are formed.

A thickness of the concavo-convex portion 32, that is, a depth of the concave portion 30 or a height of the convex portion 31, which is indicated by “a” in FIG. 3C, is 100 [nm]. This is for the purpose of meeting an optical requirement without blocking visible light by the lens cover 25, namely this is to make the lens cover 25 transparent to the visible light. The optical requirement can be satisfied when the thickness of the concavo-convex portion 32 is made to be smaller than one-fourth (¼) of wave length of the visible light, so that the visible light is not blocked by the lens cover 25. A diameter of a top surface portion 31a of the convex portion 31, which is indicated by “b” in FIG. 3C, is 95 [nm], while a distance on an opening side surface 30a between the neighboring top surface portions 31a (that is, a minimum distance between the convex portions 31 on the opening side surface 30a), which is indicated by “c” in FIG. 3C, is 285 [nm].

A pitch of the concavo-convex portion 32 is, therefore, 380 [nm]. This is also for the purpose of meeting the optical requirement without blocking the visible light by the lens cover 25. The optical requirement can be satisfied when the pitch of the concavo-convex portion 32 is made to be smaller than a range (380 [nm]-760 [nm]) of the wave length of the visible light, so that the visible light is not blocked by the lens cover 25.

Furthermore, this is for the purpose of meeting super-hydrophobic requirement. Namely, the super-hydrophobic requirement can be satisfied when the following mathematical formula of Cassie is satisfied:

cos θ_{f}=A₁·cos θ₁+A₂·cos θ₂

“θ_{f}”=contact angle for satisfying the super-hydrophobic requirement=150 degrees;

“θ₁”=contact angle of material of the convex portion 31=80 degrees;

“θ₂”=contact angle of air=180 degrees;

“A₁”=an area of the top surface portion 31a of the convex portion 31;

“A₂”=an area of the opening side surface 30a of the concave portion 30.

According to the above formula, it is obtained that

A₁:A₂=1:9

In addition, as a result that the diameter of the top surface portion 31a of the convex portion 31 is made to be 95 [nm], and the distance on the opening side surface 30a between the neighboring top surface portions 31a is made to be 285 [nm], a ratio of the area of the opening side surface 30a of the concave portion 30 with respect to the area of the top surface portion 31a of the convex portion 31 is made to be larger than 9.

According to the above structure, the lens cover 25 is rotated so as to generate a centrifugal force, so that attachment adhered to the lens cover 25 may be loosed (flown away) by the centrifugal force (the attachment is separated from the outer surface 25a of the lens cover 25) to thereby remove the attachment. It is necessary to generate the centrifugal force, which is larger than the adherence of the attachment to the outer surface 25a of the lens cover 25, in order to loose (fly away) the attachment. The centrifugal force necessary for loosing the attachment, namely necessary rotational speed of the electric motor 9, is estimated by measuring the adherence of the attachment to the outer surface 25a of the lens cover 25. Therefore, the adherence of the attachment to the outer surface 25a of the lens cover 25 is measured in the following manner, in order to estimate the rotational speed necessary for loosing (flying away) the attachment.

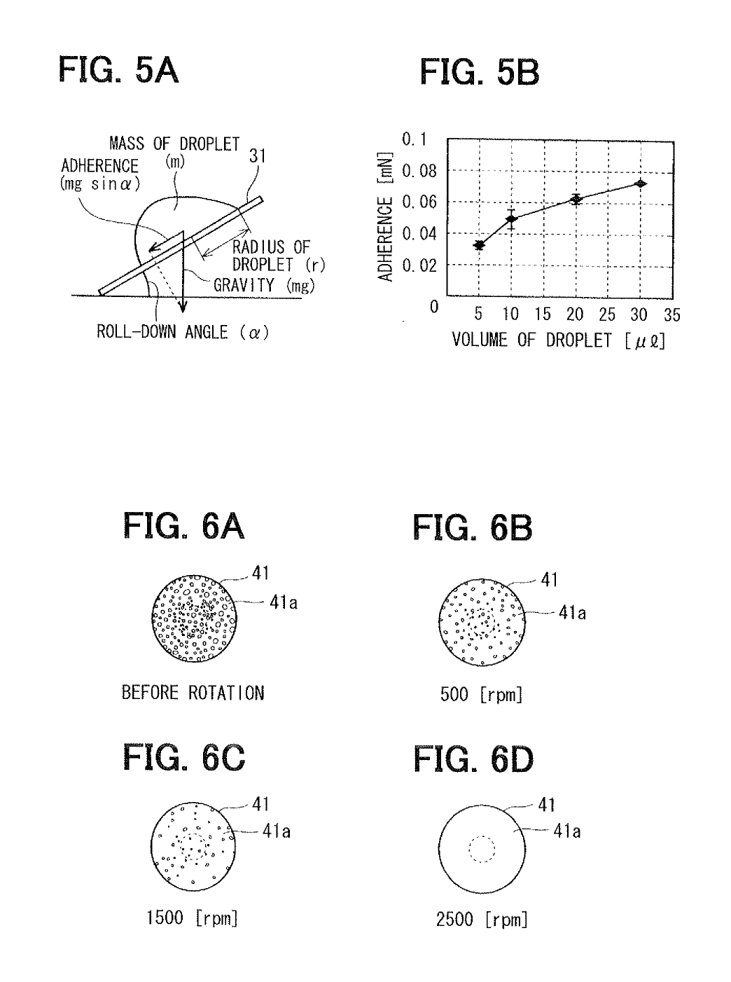

As shown in FIG. 5A, a roll-down method is used to measure adherence of water droplet to a glass plate, wherein the lens cover 25 is regarded as the glass plate. According to a result of the measurement by the roll-down method, 0.035 [mN] is measured as the adherence of the water droplet of 5 [μl] to the glass plate, as shown in FIG. 5B.

The adherence of the water droplet to the glass plate is expressed in the following formula:

F=m·r·ω²=m·r·(2π·N/60)²

wherein,

“F [N]”=the adherence of the water droplet to the glass plate;

“m [kg]”=a mass of the water droplet;

“r [m]”=a distance from a rotational center;

“ω[rad/s]”=an angular speed; and

“N [rpm]”=a rotational speed.

Accordingly, the rotational speed can be expressed in the following formula:

N={F/(m·r)}^{1/2}·(30/π)

When the following figures are substituted into the above formula;

“m”=5 [μl]: the mass of the water droplet;

“F”=0.035 [mN]: the adherence of the water droplet; and

“r”=0.1 [mm]: the distance from the rotational center,

the rotational speed “N” is obtained in the following way:

N={0.035 [mN]/(5 [μl]·0.1 [mm])}^{1/2}·(30/π)≈2500 [rpm]

Then, an experimental apparatus for demonstration is manufactured, according to which a lens cover 41 (FIGS. 6A-6D) equivalent to the lens cover 25 is rotated. The inventors confirmed by use of the experimental apparatus whether the rotational speed calculated from the above formula is reasonable or not. In the experiments, water is sprayed by an atomist spray to an outer surface 41a of the lens cover 41, so that the water is attached to the outer surface 41a. A degree for removing the water droplet is evaluated for respective rotational speeds of the lens cover 41. In the experiments, a rotational time is 10 [s]. FIGS. 6A to 6D show the experimental results. In the cases of the rotational speed of 500 [rpm] and 1500 [rpm], the water droplet adhered to the outer surface 41a of the lens cover 41 is not sufficiently removed. In the case of the rotational speed of 2500 [rpm], the water droplet adhered to the outer surface 41a of the lens cover 41 is sufficiently removed. Therefore, this experiment shows that the rotational speed calculated by the above formula is reasonable.

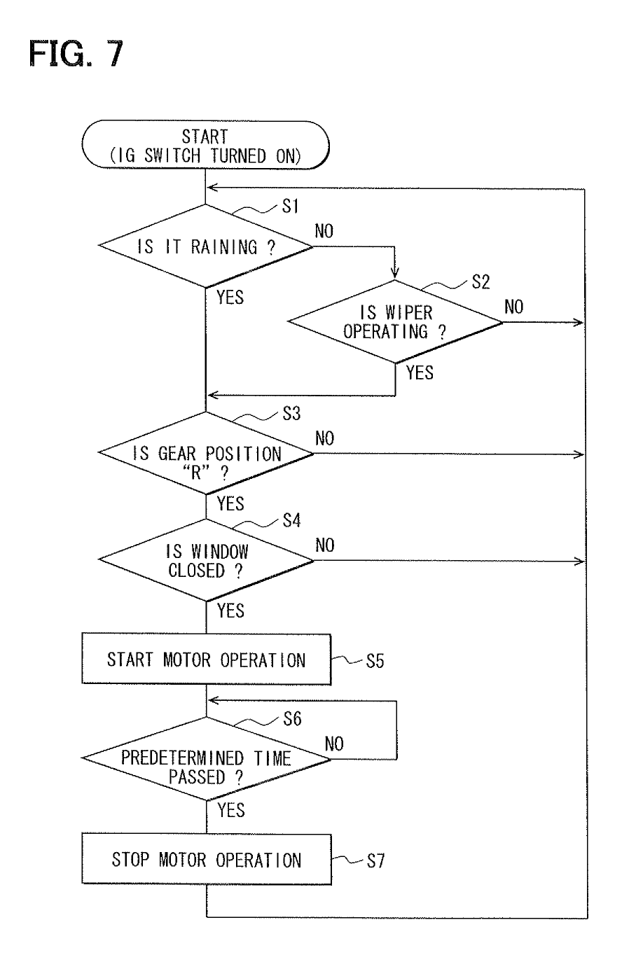

An operation of the above structure will be explained with reference to FIG. 7, which is a flow chart showing a process to be carried out by the control portion 26 of the camera ECU 3.

When an ignition switch is turned off, the control portion 26 is operated in a low consumption mode of electric power, in which the control portion 26 monitors an ignition signal. The control portion 26 determines based on the ignition signal whether the ignition switch is changed from a turn-off condition to a turn-on condition. When the control portion 26 determines based on the ignition signal that the ignition switch is changed from the turn-off condition to the turn-on condition, an operation mode for the control portion 26 is changed from the low consumption mode to a normal operation mode. At a step S1, the control portion 26 monitors a rain signal to determine whether it is raining or not, and at a step S2 the control portion 26 monitors a wiper signal to determine whether a wiper is being operated.

When the control portion 26 determines based on the rain signal that it is in a raining condition (YES at the step S1), the control portion 26 determines at a step 53 whether a gear position is in an “R” position or not, namely whether a vehicle is moving in a backward direction or not. When the control portion 26 determines based on a gear signal that the gear is in the “R” position (YES at the step S3), the process goes to a step S4 to determine whether a vehicle window is opened or closed. When the control portion 26 determines based on a window condition signal that the vehicle window is, closed (YES at the step S4), the control portion 26 starts (at a step S5) an output of a command signal for motor operation to the driver circuit 27. Then, the electric motor 9 is rotated to thereby rotate the outer rotor 13 together with the lens cover 25, at a speed of 2500 [rpm].

The control portion 26 determines at a step S6 whether a predetermined time (for example, 10 [s]) has passed over since starting the operation of the electric motor 9. When the control portion 26 determines that the predetermined time has passed over (YES at the step S6), the control portion 26 terminates the output of the command signal for the motor operation to the driver circuit 27 to terminate the motor operation (at a step S7). The rotation of the outer rotor 13 and the lens cover 25 is stopped and the process goes back to the step S1.

When the control portion 26 determines based on the wiper signal that the wiper is being operated (YES at the step S2), the process of the following steps S3 to S7 is carried out. Namely, when it is in the raining condition or the wiper is being operated, subject to a condition that the gear is in the “R” position and the vehicle window is closed, the electric motor 9 is operated for the predetermined time period to rotate the outer rotor 13 together with the lens cover 25 for the predetermined period.

According to the above first embodiment, the camera unit 10 is provided in the hollow portion 14 of the electric motor 9 to effectively use the space of the hollow portion 14. Accordingly, a size of the camera device 1 is made to be almost equal to that of the electric motor 9, in spite that the camera unit 10 is incorporated into the electric motor 9. In addition, when the electric motor 9 is rotated, the lens cover 25 (provided at the front side of the camera lens 16) is rotated together with the outer rotor 13. Therefore, even in the case the attachment, such as water droplet, mud, dust and so on is adhered to the outer surface 25a of the lens cover 25, it is possible to sufficiently remove such attachment from the outer surface 25a of the lens cover 25 when the lens cover 25 is rotated to generate the centrifugal force which will be applied to the attachment. Furthermore, if the camera lens 16 was rotated, it would be necessary to accurately adjust a mechanical structure and so on in order to eliminate an adverse affect to optical characteristics. However, such accurate adjustment is not necessary for the structure of the above embodiment, in which not the lens 16 but the lens cover 25 is rotated.

In addition, since the lens cover 25 is rotated at the rotational speed higher than 2500 [rpm], it is possible to effectively remove the attachment adhered to the outer surface 25a of the lens cover 25.

Furthermore, the concavo-convex portion 32, which has a configuration meeting the super-hydrophobic requirement expressed by the mathematical formula of Cassie, is provided at the outer surface 25a of the lens cover 25 neighboring to the rotational axis of the electric motor 9. It is, therefore, also possible to sufficiently remove the attachment adhered to such portion of the outer surface 25a close to the rotational axis, at which the centrifugal force applied to the attachment is relatively small.

In addition, the thickness of the concave-convex portion 32 in the direction perpendicular to the opening side surface 30a of the outer surface 25a is made to be less than 100 [nm], so that the thickness in the direction perpendicular to the opening side surface 30a is less than one-fourth (¼) of the wave length of the visible light. Therefore, the visible light is not blocked by the concavo-convex portion 32 to assure a proper photographing performance.

In addition, the ratio of the area of the opening side surface 30a of the concave portion 30 with respect to the area of the top surface portion 31a of the convex portion 31 is made to be larger than 9, so that the pitch of the concavo-convex is made to be within the range of the wave length of the visible light. Therefore, the visible light is not blocked, either, by the concavo-convex portion 32 to assure the proper photographing performance.

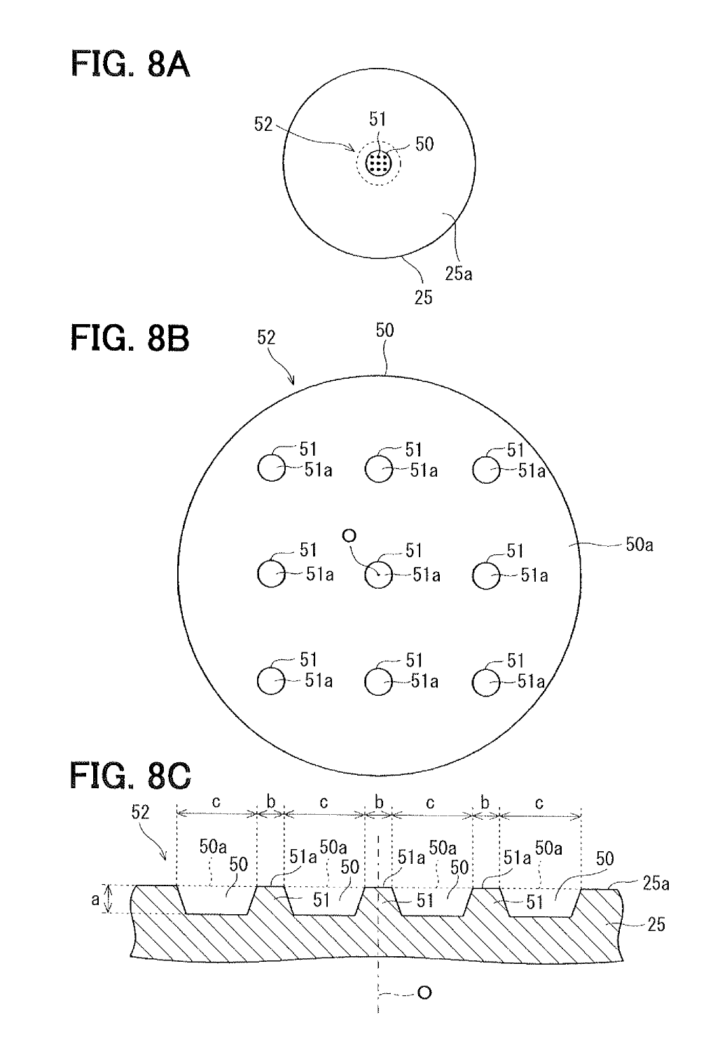

According to the above embodiment, the top surface portion 31a of the convex portion 31 is formed in the concavo-convex portion 32, so that the convex portion 31 is projecting outwardly from the outer surface 25a of the lens cover 25. However, as shown in FIGS. 8A to 8C, a concave-convex portion 52 having concave portions 50 and convex portions 51 may be formed in such a way that a top surface portion 51a of the convex portion 51 is arranged on a surface which is the same to the outer surface 25a of the lens cover 25. Even in this case, the optical requirement for the lens cover 25 not blocking the visible light is satisfied. For example, a diameter of the top surface portion 51a of the convex portion 51 is made to be 95 [nm], while a distance on an opening side surface 50a between the neighboring top surface portions 51a is made to be 285 [nm]. And a pitch of the concave-convex is made to be 380 [nm].

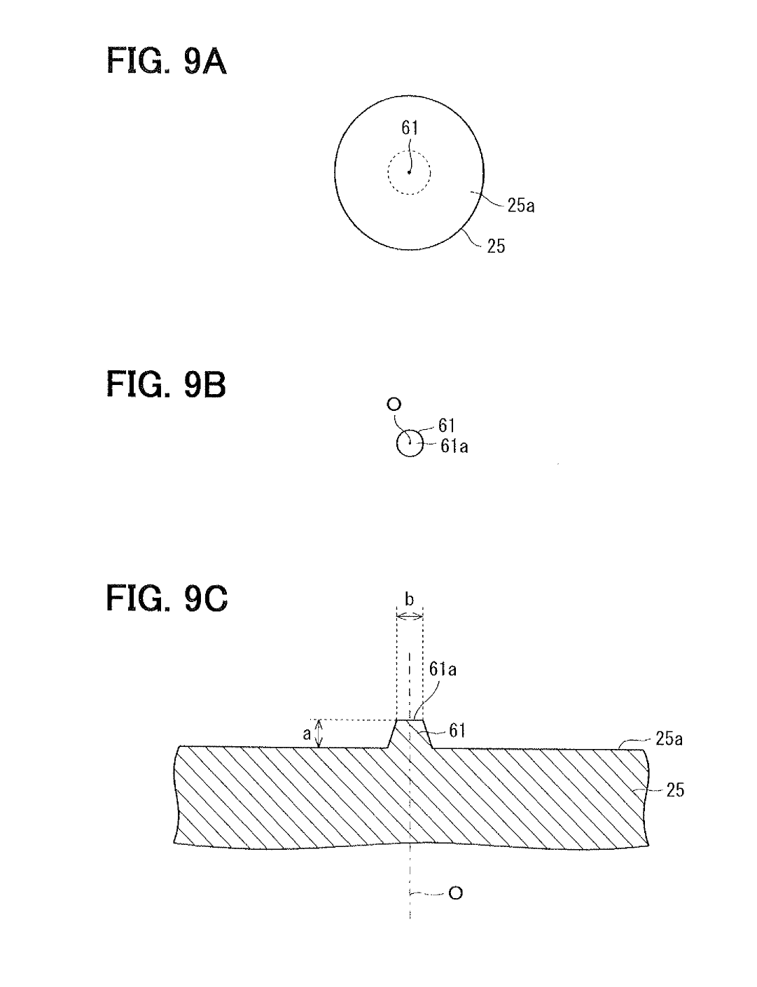

Alternatively, as shown in FIGS. 9A to 9C, one convex portion 61 may be formed such that the convex portion 61 is coaxial with the rotational axis of the electric motor 9 and a top surface portion 61a of the convex portion 61 is projecting outwardly from the outer surface 25a of the lens cover 25.

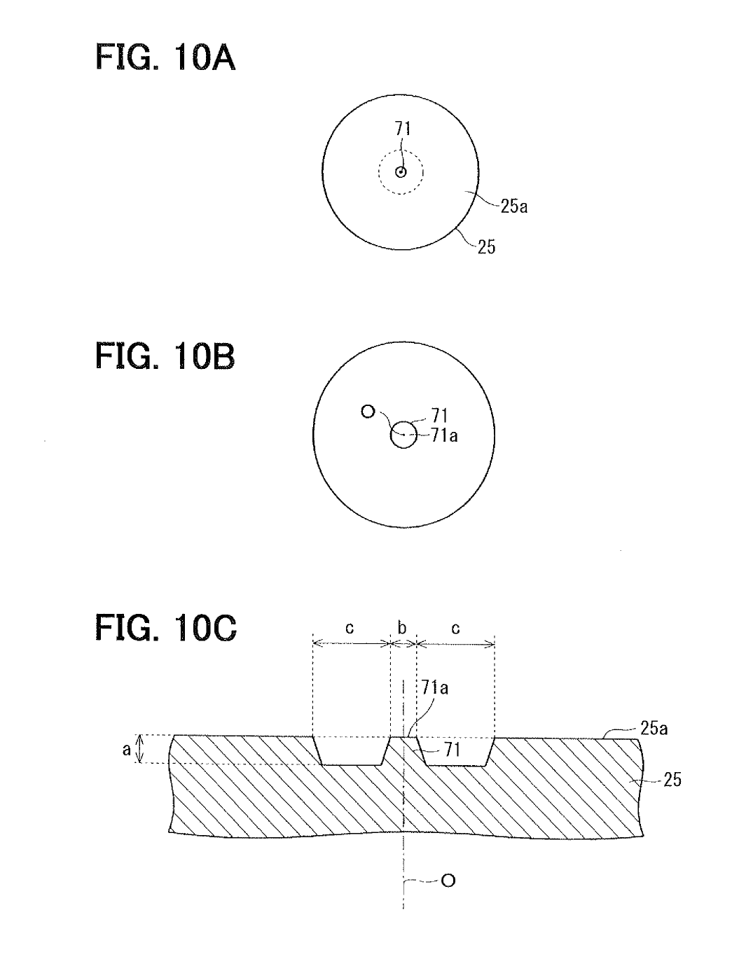

Furthermore, as shown in FIGS. 10A to 10C, one convex portion 71 may be alternatively formed such that the convex portion 71 is coaxial with the rotational axis of the electric motor 9 and a top surface portion 71a of the convex portion 71 is arranged on a surface, which is the same to the outer surface 25a of the lens cover 25.

According to the above embodiment, the electric motor 9 is operated for the predetermined time period, when it is in the raining condition or the wiper is being operated, subject to the condition that the gear is in the “R” position and the vehicle window is closed.

However, the electric motor 9 may be operated, when at least one of the following conditions is satisfied:
it is in the raining condition;
the wiper is being operated;
the gear is in the “R” position; and
the vehicle window is closed.

Furthermore, the electric motor 9 may be operated for the predetermined time period when one of or some of the above conditions are satisfied.

### Second Embodiment

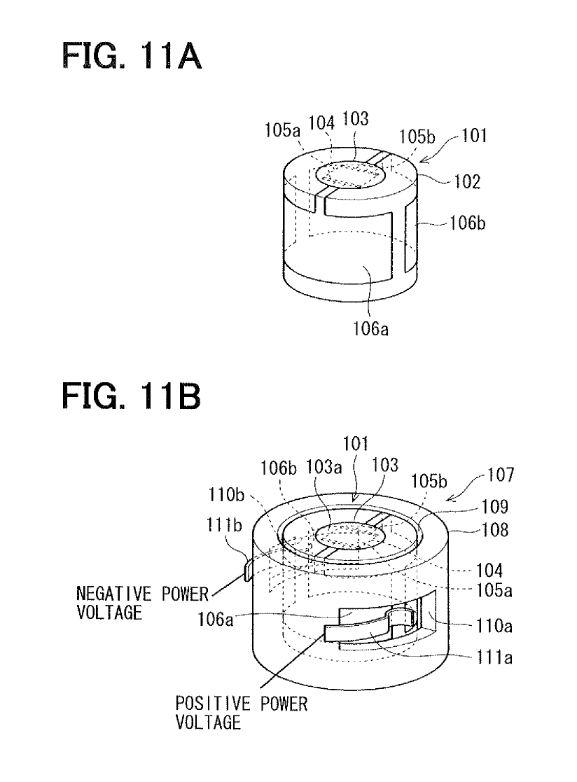

A second embodiment of the present invention will be explained with reference to FIGS. 11A. and 11B. The second embodiment differs from the first embodiment in that a transparent heating device is provided at an inner surface (a backside surface opposite to the outer surface) of the lens cover. Alternate current is supplied to the transparent heating device as a driving current therefor,

A motor 101 is identical to the electric motor 9 of the first embodiment in its basic structure, according to which the camera unit is provided in the hollow portion thereof. As shown in FIG. 11A, a lens cover 103 of a disc shape is provided at an upper portion of a motor casing 102 and a transparent heater 104 (a heating device) is provided at an inner side surface of the lens cover 103.

The transparent heater 104 is, for example, formed in the following manner. A transparent heating element is formed on a gamut of a glass substrate or a plastic substrate. A first electrode 105a and a second electrode 105b are respectively formed at both side ends of the heating element, so that electric power is supplied to the heating element via the first and second electrodes 105a and 105b. Namely, when a positive voltage is applied to the first electrode 105a, a negative voltage is applied to the second electrode 105b. On the other hand, when the negative voltage is applied to the first electrode 105a, the positive voltage is applied to the second electrode 105b. When the electric power is supplied to the heater 104 as above, namely the positive and negative voltages are alternately applied to the first and second electrodes, the heater 104 generates heat.

A first terminal 106a is formed at a half of an outer peripheral surface of the motor casing 102, wherein the first terminal 106a is electrically connected to the first electrode 105a. In a similar manner, a second terminal 106b is formed at another half of the outer peripheral surface of the motor casing 102, wherein the second terminal 106b is electrically connected to the second electrode 105b.

As shown in FIG. 11B, a cylindrical motor cover 107 is provided at an outer periphery of the electric motor 101. More exactly, a main body 108 of the motor cover 107 is formed in a cylindrical shape and the electric motor 101 is rotatably accommodated in a hollow space 109 of the main body 108. A first window portion 110a and a second window portion 110b are respectively formed at a peripheral wall of the main body 108. A. first spring arm. 111a and a second spring arm 111b are respectively provided at the first and second window portions 110a and 110b.

A forward end of the first spring arm 111a is formed in an arc shape, which is inserted through the first window portion 110a and inwardly biased to the outer peripheral surface of the motor casing 102, at which the first and second terminals 106a and 106b are formed. In the same manner, a forward end of the second spring arm 111b is formed in an arc shape, which is inserted through the second window portion 110b and inwardly biased to the outer peripheral surface of the motor casing 102. When the motor casing 102 is rotated in the hollow space 109, each forward end of the first and second spring arms 111a and 111b is alternately brought into contact with the first and second terminals 106a and 106b.

When the positive voltage is applied to the first spring arm 111a, while the negative voltage is applied to the second spring arm 111b, during the rotation of the motor 101, the positive voltage is periodically and alternately applied to the first and second terminals 106a and 106b via the first spring arm 111a and the negative voltage is periodically and alternately applied to the first and second terminals 106a and 106b via the second spring arm 111b. As a result, the voltage of alternate current is supplied to the transparent heater 104, so that heat is generated at the transparent heater 104. The heat generated at the transparent heater 104 is transmitted from the inner backside surface of the lens cover 103 to an outer surface 103a of the lens cover 103.

According to the above second embodiment, the transparent heater 104 is provided at the inner backside surface of the lens cover 103 so as to heat the lens cover 103, and the voltage of alternate current is supplied to the transparent heater 104 during the motor 101 is rotated. Accordingly, the heat generated at the transparent heater 104 is transmitted from the backside surface to the outer surface 103a of the lens cover 103 to thereby prevent the outer surface 103a of the lens cover from being misted over. In other Words, it is possible not only to remove the attachment but also to prevent a condition of being misted over. As a result, a clear image can be provided to the user (a vehicle driver).

### Third Embodiment

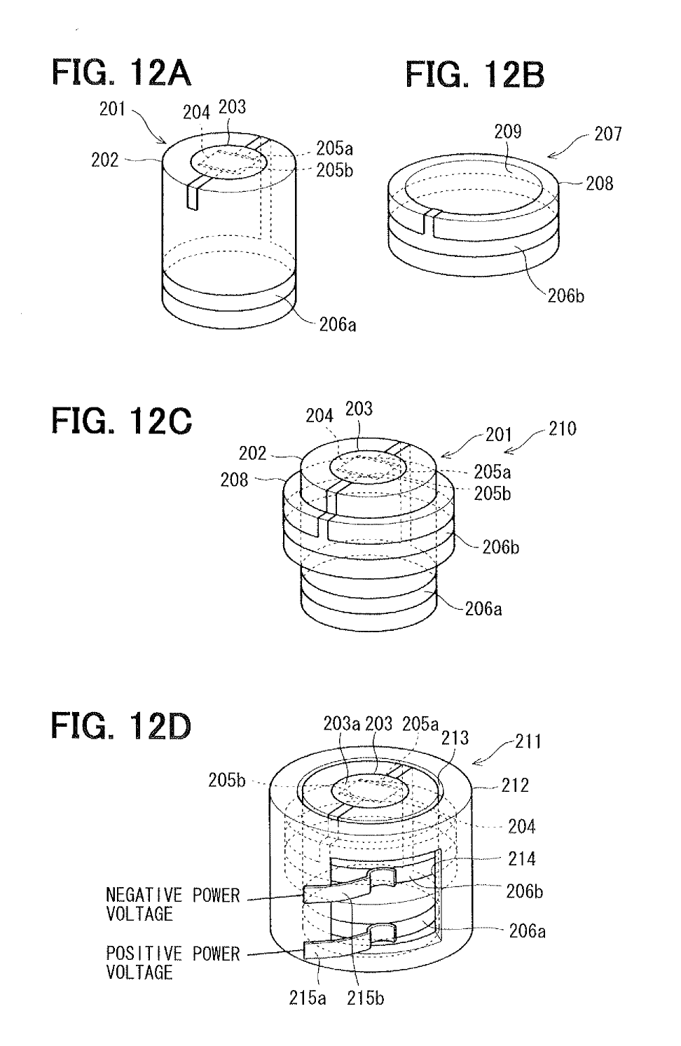

A third embodiment of the present invention will be explained with reference to FIGS. 12A to 12D. In a similar manner to the second embodiment, the third embodiment differs from the first embodiment in that a transparent heating device is provided at an inner surface (a backside surface opposite to the outer surface) of the lens cover. However, the third embodiment differs from the second embodiment in that direct current is supplied to the transparent heating device as a driving current therefor.

A length of an electric motor 201 in its axial direction is made larger than that of the electric motor 9 of the first embodiment. A basic structure for the motor 201, for example, a structure in which the camera unit is provided in the hollow portion, is the same to that of the electric motor 9. As shown in FIG. 12A, a lens cover 203 of a disc shape is provided at an upper portion of a motor casing 202 and a transparent heater 204 (a heating device) is provided at an inner side surface of the lens cover 203.

In a similar manner to the transparent heater 104 of the second embodiment, the transparent heater 204 is, for example, formed in the following manner. A transparent heating element is formed on a gamut of a glass substrate or a plastic substrate. A first electrode 205a and a second electrode 205b are respectively formed at both side ends of the heating element, so that electric power is supplied to the heating element via the first and second electrodes 205a and 205b. For example, a positive voltage is applied to the first electrode 205a, while a negative voltage is applied to the second electrode 205b. When the electric power is supplied to the heater 204 as above, the heater 204 generates heat.

A first terminal 206a of an annular shape is formed at an outer peripheral surface of the motor casing 202, wherein the first terminal 206a is electrically connected to the first electrode 205a.

As shown in FIG. 12B, a main body 208 of a cylindrical member 207 is formed in a cylindrical shape and a diameter of a hollow portion 209 (an inner diameter of the cylindrical member 207) is made to be almost equal to an outer diameter of the electric motor 201. A longitudinal length of the cylindrical member 207 is made to be smaller than that of the electric motor 201. As shown in FIG. 12C, the electric motor 201 is inserted into the hollow portion 209 of the cylindrical member 207, so that both of them are connected to each other to form an integral unit 210. A second terminal 206b of an annular shape is formed at an outer peripheral surface of the cylindrical member 207, wherein the second terminal 206b is electrically connected to the second electrode 205b when the motor 201 is inserted into and connected to the cylindrical member 207.

As shown in FIG. 12D, a cylindrical motor cover 211 is provided at an outer periphery of the electric motor 201. More exactly, a main body 212 of the motor cover 211 is formed in a cylindrical shape and the integral unit 210 (the electric motor 201 and the cylindrical member 207) is rotatably accommodated in a hollow space 213 of the main body 212. A window portion 214 is formed at a peripheral wall of the main body 212. A first spring arm 215a and a second spring arm 215b are respectively provided at the window portion 214.

Each forward end of the first and second spring arms 215a and 215b is formed in an arc shape, which is inserted through the window portion 214 and inwardly biased to the respective outer peripheral surfaces of the integral unit 210, at which the first and second terminals 206a and 206b are respectively formed. Therefore, in a condition that the integral unit 210 is rotatably accommodated in the hollow space 213 of the motor cover 211, the forward end of the first spring arm 215a is brought into contact with the first terminal 206a, while the forward end of the second spring arm 215b is brought into contact with the second terminal 206b.

According to the above structure, when the positive voltage is applied to the first spring arm 215a, while the negative voltage is applied to the second spring arm 215b, during the electric motor 201 is operated, the positive and negative voltages are continuously applied to the first and second terminals 206a and 206b via the respective spring arms 215a and 215b. As a result, direct current is supplied to the transparent heater 204 during the operation of the electric motor 201, so that the heat is generated at the heater 204. The heat generated at the transparent heater 204 is likewise transmitted from the inner backside surface of the lens cover 203 to an outer surface 203a of the lens cover 203.

According to the third embodiment, the transparent heater 204 is provided at the inner backside surface of the lens cover 203 so as to heat the lens cover 203, and the electric power of direct current is supplied to the transparent heater 204 during the motor 201 is rotated. Accordingly, in the same manner to the second embodiment, the heat generated at the transparent heater 204 is transmitted from the backside surface to the outer surface 203a of the lens cover 203 to thereby prevent the outer surface 203a of the lens cover from being misted over. In other words, it is possible not only to remove the attachment but also to prevent the condition of being misted over. As a result, a clear image can be provided to the user (a vehicle driver).

### Other Embodiments

The present invention should not be limited to the above embodiments, but may be modified or expanded in various ways as below.

The optical sensor is not limited to the camera unit 10, but may be other sensors, such as a laser device, so long as the sensor is a device having a lens for optically measuring physical values.

The electric motor 9 is not limited to the abduction type motor, but maybe an adduction type motor, which has a hollow space and in which an inner rotor is arranged in an inside of a stator.

The hydrophobic film may not be always formed at the outer surface 25a of the lens cover 25. A hydrophilic treatment, a photo-catalyst treatment or an antifouling treatment maybe carried out for the outer surface 25a of the lens cover 25, so that the outer surface 25a is coated with a hydrophilic film, a photo-catalyst film or an antifouling film. Even according to such a structure, it is possible to make the lens cover 25 in such a condition that attachment may not be easily adhered to the outer surface 25a of the lens cover 25.

The optical sensor may be arranged in a metal housing, which is then disposed in the inside of the hollow portion 14 of the electric motor 9. In such a case, it is possible to protect the optical sensor from noises generated during the operation of the electric motor 9. It is, therefore, possible to avoid a situation that the optical sensor may malfunction due to the noises from the motor 9 or the images may be deteriorated as a result of such malfunction.

The camera assembly 2 may not be always mounted to the door knob of the rear door 6 of the vehicle 4, but may be mounted to a bumper, a lower portion of aside mirror attached to a vehicle door, or a front grill of the vehicle.

The image comparing portion 28 stores image information photographed by the camera unit 10 and compares the latest image information with the previously-stored image information. When there is no difference between the current and previous image information, the control portion 26 may stop the operation of the electric motor 9. When the attachment is removed, there appears no change in the photographed image even after the lens cover 25 has been rotated. The operation of the electric motor 9 can be stopped, when the attachment has been removed. As a result, it is possible to reduce electric power consumption for the optical sensor device. When comparing (determining) the difference between the image information, difference of each picture element may be determined, or relative difference (relative change) between the images may be determined.

The operation of the electric motor 9 may be started based on one of the following conditions;
the user (the vehicle driver) has operated a predetermined switch;
the user generated a predetermined sound (which is determined by a voice-recognition system, for example); and
clarity of electronic image signals (data-processed image signals) is digitalized and such digitalized clarity is lower than a predetermined value (namely, when it is determined that the attachment is adhered).

In the similar manner, the operation of the electric motor 9 maybe stopped, when one of the following conditions is satisfied:
the user (the vehicle driver) has operated the predetermined switch;
the user generated the predetermined sound (which is determined by the voice-recognition system, for example); and
the digitalized clarity for the image is higher than a predetermined value (namely, when it is determined that the attachment has been removed).

Furthermore, a period for the operation of the electric motor 9 may be a predetermined period, or the electric motor 9 may be operated during a period in which any operational condition is satisfied.

What is claimed is:

1. An optical sensor device for a vehicle comprising:
an electric motor having a rotor and a stator, the electric motor having a hollow portion;
a motor driving portion for driving the electric motor;
an optical sensor unit having a lens and provided in the hollow portion at such a position, at which the lens is coaxial with a rotational axis of the electric motor; and
a lens cover attached to the rotor and provided at a front side of the optical sensor unit, so that the lens cover is rotated together with the rotor.

2. The optical sensor device according to the claim 1, wherein
the rotor is arranged at an outer periphery of the stator, and
the hollow portion is formed in an inside of the stator.

3. The optical sensor device according to the claim 1, wherein
the rotor is arranged at an inner periphery of the stator, and
the hollow portion is formed in an inside of the rotor.

4. The optical sensor device according to the claim 1, wherein
the lens cover is rotated at a rotational speed higher than 2500 [rpm].

5. The optical sensor device according to the claim 1, wherein
a concavo-convex portion having multiple concave portions and convex portions, which has a configuration satisfying super-hydrophobic requirement expressed by mathematical formula of Cassie, is formed on an outer surface of the lens cover at such a position around a rotational axis of the electric motor.

6. The optical sensor device according to the claim 5, wherein
a thickness of the concavo-convex portion in a direction perpendicular to the outer surface of the lens cover is less than 100 [nm].

7. The optical sensor device according to the claim 5, wherein
a ratio of an area of an opening side surface of the concave portion with respect to an area of a top surface portion of the convex portion is larger than 9.

8. The optical sensor device according to the claim 1, wherein
a concave portion or a convex portion, which has a configuration satisfying super-hydrophobic requirement expressed by mathematical formula of Cassie, is formed on an outer surface of the lens cover at such a position around a rotational axis of the electric motor.

9. The optical sensor device according to the claim 8, wherein
a thickness of the concave portion or the convex portion in a direction perpendicular to the outer surface of the lens cover is less than 100 [nm].

10. The optical sensor device according to the claim 1, further comprising:
a heating device provided at a portion close to the lens cover for heating an outer surface of the lens cover.

11. The optical sensor device according to the claim 1, further comprising:
an electronic control unit for receiving a gear position signal,
wherein the electronic control unit operates the electric motor when it determines that a gear position is in an “R” position.

12. The optical sensor device according to the claim 1, further comprising:
an electronic control unit for receiving a rain signal,
wherein the electronic control unit operates the electric motor when it determines that it is in a raining condition.

13. The optical sensor device according to the claim 1, further comprising:
an electronic control unit for receiving a wiper signal,
wherein the electronic control unit operates the electric motor when it determines that a wiper device is being operated.

14. The optical sensor device according to the claim 1, further comprising:
an electronic control unit for receiving a window signal,
wherein the electronic control unit operates the electric motor when it determines that a vehicle window is closed.

15. The optical sensor device according to the claim 1, further comprising:
an electronic control unit having an image comparing portion for memorizing image information photographed by the optical sensor unit, the image comparing portion comparing a current image information with a memorized previous image information,
wherein an operation of the electric motor is stopped when the image comparing portion determines that there is no difference between the above two image information.
